(19) United States
(12) Patent Application Publication
(10) Pub. No.: US 2024/0202756 A1
(43) Pub. Date: Jun. 20, 2024

(54) AUTOMATIC COLLECTION AND PROCESSING OF ENTITY INFORMATION

(71) Applicant: The Toronto-Dominion Bank, Toronto (CA)

(72) Inventors: Moshe Karl, Petah Tikva (IL); Nir Agiv, Ramat Gan (IL); David Allie Shay, Sautee Nacoochee, GA (US)

(21) Appl. No.: 18/082,465

(22) Filed: Dec. 15, 2022

(51) Int. Cl. G06Q 30/0204; G06F 40/166; G06F 40/205; G06F 40/279; G06F 40/30

(52) U.S. Cl. CPC G06Q 30/0204; G06F 40/166; G06F 40/205; G06F 40/279; G06F 40/30

(57) ABSTRACT

This disclosure involves systems, software, and computer implemented methods for automatically generating and storing business entity summaries in a uniform format, including obtaining at least one identifier of an entity, and based on the at least one identifier obtaining information about the entity from two or more disparate sources. The obtained information can be parsed based on a semantic analysis of at least one source to generate a summary of the entity including one or more attributes associated with the entity. The summary of the entity is stored in a database.

### TECHNICAL FIELD

This disclosure generally relates to computer-implemented methods, software, and systems for retrieving, and analyzing attributes and features of entities.

### BACKGROUND

Many organizations interact with a multitude of entities (e.g., vendors, customers, suppliers, etc.). In some instances, multiple entities compete, each offering varying quality products or services. A discerning organization may decide to maintain notes regarding particular entity information for rapid comparison and discrimination between similar entities.

### SUMMARY

In general, this disclosure involves systems, software, and computer implemented methods for automatically generating and storing business entity summaries in a uniform format, including obtaining at least one identifier of an entity, and based on the at least one identifier obtaining information about the entity from two or more disparate sources. The obtained information can be parsed based on a semantic analysis of at least one source to generate a summary of the entity including one or more attributes associated with the entity. The summary of the entity is stored in a database.

Implementations can optionally include one or more of the following features.

In some instances, the one or more attributes associated with the entity are determined by executing a machine learning model that is trained using sample information of a plurality of sample entities and a plurality of sample attributes associated with the plurality of sample entities. In some instances, executing the machine learning model includes performing a topic classification on the obtained information, performing a sentiment analysis of the obtained information, and performing attribute classification of the obtained information.

In some instances, stakeholder attributes of a plurality of stakeholders are maintained, each stakeholder corresponding to one or more stakeholder attributes, and determining that at least one of the one or more attributes associated with the entity corresponds to a stakeholder attribute of a stakeholder and sending the summary of the entity to a computing device of the stakeholder.

In some instances, a query request is received that includes one or more keywords to query entities. An attribute of a particular entity that corresponds to the one or more keywords is determined and a summary of the particular entity is sent in response to the query request.

In some instances, where the attribute of the particular entity that corresponds to the one or more keywords corresponds to two or more particular entities, and a comparison between the two or more particular entities is generated based on a generated relevance score between the one or more keywords and the determined attribute. The generated comparison of the two or more particular entities can be sent in response to the query request.

In some instances, obtaining the at least one identifier of an entity includes receiving an email where the subject of the email contains the identifier. In some instances the body of the email includes human-generated insights associated with the entity, and the human generated insights are stored with the summary in the database. In some instances, the human generated insights include a score of the entity that is associated with a category of the entity.

Similar operations and processes may be performed in a different system comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations may also be contemplated. Additionally, similar operations can be associated with or provided as computer-implemented software embodied on tangible, non-transitory media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 depicts an overview diagram of a system for automatically analyzing business entities.

FIG. 2 is a flowchart that describes an example method for automatically analyzing business entities.

FIG. 3 is a flowchart illustrating an example process for sending push notifications.

### DETAILED DESCRIPTION

The solution described herein automates the process of collecting, analyzing, and maintaining a database of business entity information. At a high level, a server can obtain an identifier of a business entity (e.g., a name or a URL of the entity) whose information is to be collected and analyzed. The server can then collect the business entity's information from one or more sources including, but not limited to, a website of the business entity, news websites, paid third-party services, etc. The server can then parse the collected information to generate, based on a predetermined format, a summary of the business entity and store the summary in a database. Parsing of the collected information can include a semantic analysis using one or more methods, including machine learning, to extract attributes and details about the business entity from the collected data.

In some implementations, this entire process is triggered by an email or other message sent to a backend system, which then proceeds from information collection to an entity summary with no further human input. Other suitable messages can be, for example, a slack message sent to a smart client or a bot. Or a voice command sent to a voice-activated assistant.

This solution thus achieves significant benefits and advantages over the conventional methods. First, unlike the conventional methods that employ manual processes to collect and analyze the information of the large quantity of potential suppliers, the solution increases efficiency by automating the collections and analysis of the potential suppliers' information. Therefore, summaries of the business entities can be quickly generated to aid a supplier searcher in narrowing down the candidate suppliers. Second, instead of relying on a human workforce to review and analyze the information of suppliers, the solution can collect information from a large quantity of sources and assess the supplier based on large a volume of data. This can generate a more accurate assessment of suppliers than conventional methods.

In some implementations, the information is collected in response to a trigger event. The trigger event can be a message (e.g., email, slack message, etc.) or there event such as a post on LinkedIn, a news article, a public disclosure filing, or other event.

Once the information is collected, the company or companies collecting the data can quickly review the information and vendors at a later date, including when the need for the type of services of the vendor arises, but after prior discussions with vendors of that type. Ranking and evaluation of those vendors can occur at a later date, using keywords for the need and bringing up two or more vendors providing similar or related services to those keywords/needs. For example, if a user requests a “cloud analytics provider” a database of summaries can be queried, returning a number of results within the category “cloud analytics provider.” These results can be automatically compared and ranked, then provided to the user with a quality score, or in ranked order.

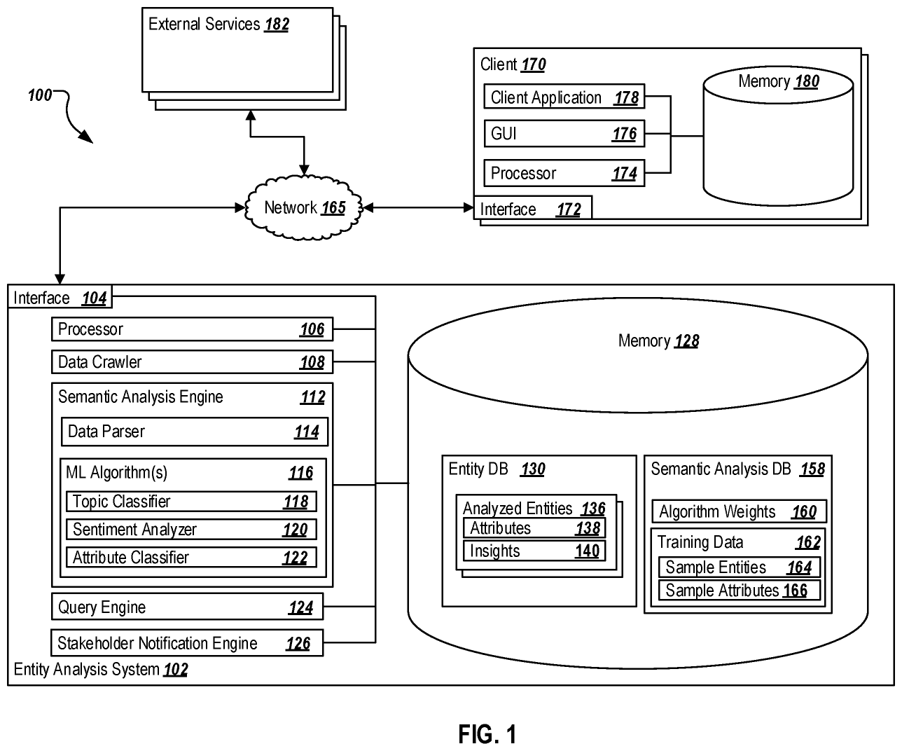

FIG. 1 depicts an overview diagram of an example system for automatically analyzing entities. The system 100 includes an entity analysis system 102, a client 170, and one or more external services 182, the entity analysis system can include a processor 106, a semantic analysis engine 112, a query engine, 124, a stakeholder notification engine 126, a memory 128, and an interface 104, and can communicate using a network 165 with client 170 and external services 182.

Processor 106 of entity analysis system 102 can be used to perform operations of the entity analysis system 102. Although illustrated as a single processor 106 in FIG. 1, multiple processors can be used according to particular needs, desires, or particular implementations of the system 100. Each processor 106 can be a central processing unit (CPU), an application specific integrated circuit (ASIC), a field-programmable gate array (FPGA), or another suitable component. Generally, the processor 106 executes instructions and manipulates data to perform the operations of the entity analysis system 102. Specifically, the processor 106 executes the algorithms and operations described in the illustrated figures, as well as the various software modules and functionality, including the functionality for sending communications to and receiving transmissions from client 170, external services 182, as well as to other devices and systems. Each processor 106 can have a single or multiple core, with each core available to host and execute an individual processing thread. Further, the number of, types of, and particular processors 106 used to execute the operations described herein can be dynamically determined based on a number of requests, interactions, and operations associated with the entity analysis system 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including C, C++, JavaScript, Java™, Visual Basic, assembler, Perl®, any suitable version of 4GL, as well as others.

The entity analysis system 102 can include, among other components, several applications, entities, programs, agents, or other software or similar components capable of performing the operations described herein. As illustrated, the entity analysis system 102 includes or is associated with the data crawler 108, semantic analysis engine 112, the query engine 124, and the stakeholder notification engine 126.

Data crawler 108 can access one or more external services 182 or other sources (e.g., web search, particular website provided via URL, one or more private databases, etc.). Data crawler 108 generally access information associated with a particular business entity and compiles it into an inclusive data store comprising available information regarding the particular business entity. In some implementations, data crawler 108 periodically queries various information sources in order to obtain updated information regarding business entities that are stored in an entity database 130 which records information on a plurality of analyzed entities 136. In some implementations, data crawler 108 accesses sources in response to a query or a prompt. For example an email can be sent from client 170 to the entity analysis system 102 using network 165. The email can include, for example, a name of a business entity and an associated URL in the subject line, which can trigger the entity analysis system 102 to perform an analysis on the named business entity, and direct the data crawler 108 to the URL to obtain information associated with the business entity.

Data crawler accesses external services 182 or other sources via interface 104. The interface 104 is used by the entity analysis system 102 for communicating with other systems in a distributed environment—including within the system 100—connected to the network 165, e.g., client 170, external services 182, and other systems communicably coupled to the illustrated entity analysis system 102 and/or network 165. Generally, the interface 104 comprises logic encoded in software and/or hardware in a suitable combination and operable to communicate with the network 165 and other components. More specifically, the interface 104 can comprise software supporting one or more communication protocols associated with communications such that the network 165 and/or interface 104 hardware is operable to communicate physical signals within and outside of the illustrated system 100. Still further, the interface 104 can allow the entity analysis system 102 to communicate with the client 170 and/or other portions illustrated within the entity analysis system 102 to perform the operations described herein.

Network 165 facilitates wireless or wireline communications between the components of the system 100 (e.g., between the entity analysis system 102, the client(s) 170, etc.), as well as with any other local or remote computers, such as additional mobile devices, clients, servers, or other devices communicably coupled to network 165, including those not illustrated in FIG. 1. In the illustrated environment, the network 165 is depicted as a single network, but can comprise more than one network without departing from the scope of this disclosure, so long as at least a portion of the network 165 can facilitate communications between senders and recipients. In some instances, one or more of the illustrated components (e.g., the data crawler 108, the semantic analysis engine 112, etc.) can be included within or deployed to network 165 or a portion thereof as one or more cloud-based services or operations. The network 165 can be all or a portion of an enterprise or secured network, while in another instance, at least a portion of the network 165 can represent a connection to the Internet. In some instances, a portion of the network 165 can be a virtual private network (VPN). Further, all or a portion of the network 165 can comprise either a wireline or wireless link. Example wireless links can include 802.11a/b/g/n/ac, 802.20, WiMax, LTE, and/or any other appropriate wireless link. In other words, the network 165 encompasses any internal or external network, networks, sub-network, or combination thereof operable to facilitate communications between various computing components inside and outside the illustrated system 100. The network 165 can communicate, for example, Internet Protocol (IP) packets, Frame Relay frames, Asynchronous Transfer Mode (ATM) cells, voice, video, data, and other suitable information between network addresses. The network 165 can also include one or more local area networks (LANs), radio access networks (RANs), metropolitan area networks (MANs), wide area networks (WANs), all or a portion of the Internet, and/or any other communication system or systems at one or more locations.

In some implementations, where the data crawler 108 is triggered to collect information by an email, a user or third party system can provide additional insights, or human created insights in the body of the email. These provided insights can be analyzed by the system and incorporated into the entity summary later. In some implementations, this additional information is stored as insights 140 in the entity database 130. These insights can be, for example, feedback on customer experience (e.g., “they were rude on the telephone”), extraneous contemporary thoughts or notes related to the entity or the encounter (e.g., “seemed like a good option when we need to work on project X”), or other details (e.g., this entity provides local companies with a 10% discount).

Semantic analysis engine 112 can use a data parser 114 to discretize or organize information provided by data crawler 108. For example, data parser 114 can divide information provided into text objects of a specific format. In some implementations the data parser 114 generates embeddings associated with the information, where embeddings are numerical representations of text that represent some semantic information and present a useful input for downstream machine learning techniques. In some implementations, data parser 114 can generate a bag-of-words library, or an N-gram library for additional natural language processing.

The parsed data can then be provided to one or more machine learning algorithms 116 which provide processing of the obtained information. In some implementations, the machine learning algorithms 116 can be feed-forward auto-encoder neural networks. An example machine learning algorithm 116 can be a three-layer auto-encoder neural network. The machine learning algorithm 116 may include an input layer, on or more hidden layers, and an output layer. In some implementations, the neural network has no recurrent connections between layers. Each layer of the neural network may be fully connected to the next, e.g., there may be no pruning between the layers. The machine learning algorithms 116 can include an optimizer for training the network and computing updated layer weights, such as, but not limited to, ADAM, Adagrad, Adadelta, RMSprop, Stochastic Gradient Descent (SGD), or SGD with momentum. In some implementations, the machine learning algorithms 116 may apply a mathematical transformation, e.g., a convolutional transformation or factor analysis to input data prior to feeding the input data to the network.

In some implementations, the machine learning algorithms 116 can be supervised models. For example, for each input provided to the model during training, the machine learning algorithms 116 can be instructed as to what the correct output should be. The machine learning algorithms 116 can use batch training, e.g., training on a subset of examples before each adjustment, instead of the entire available set of examples. This may improve the efficiency of training the model and may improve the generalizability of the model. The machine learning algorithms 116 may use folded cross-validation. For example, some fraction (the “fold”) of the data available for training can be left out of training and used in a later testing phase to confirm how well the model generalizes. In some implementations, the machine learning algorithms 116 may be an unsupervised model. For example, the model may adjust itself based on mathematical distances between examples rather than based on feedback on its performance.

In some examples, the machine learning algorithm 116 can provide a binary output label, e.g., a yes or no indication of whether a particular portion of text contains a business attribute of the business entity. In some examples, the machine learning algorithms 116 provide a score output. For example, the machine learning algorithms 116 can indicate a timeliness rating (e.g., timeliness score from 0-10), or a price score associated with a business entity. In some examples, the machine learning process 116 can provide an overall quality rating or score associated with a business entity. The overall quality rating can be based on a number of different business attributes as discussed in more detail below. In some implementations, the machine learning algorithms 116 send output data to one or more entity databases 130 to be stored as analyzed entities 136.

The machine learning algorithms can include one or more sub networks or separate neural classifiers such as topic classifier 118, sentiment analyzer 120, and attribute classifier 122.

Topic classifier 118 can, for example, receive a bulk of text data (e.g., from data parser 114 or data crawler 108) and can perform one or more topic modeling algorithms such as Latent Semantic Analysis (LSA) and/or Latent Dirichlet Allocation (LDA) in order to identify possible topics within the text. Then topic classification can be performed, to categorized portions of or the entire bulk text.

Sentiment analyzer 120 can be a sub-network that can generally identify a sentiment behind portions of the obtained information. In some implementations, the sentiment analyzer 120 provides a general positive or negative score associated with each category generated by the topic classifier 118. In some implementations sentiment analyzer 120 identifies sentiment directly from bulk text (e.g., provided by the data parser 114, or data crawler 108). Example sentiments can be, for example, positive or negative, or likelihood of description of a quantitative or qualitative attribute of the business entity. The sentiment analyzer 120 can include a Naïve Bayes algorithm, linear regressions, support vector machine algorithms, deep learning algorithms, or a combination thereof.

Attribute classifier 122 can identify and quantify attributes associated with the business entity. In some implementations, attribute classifier 122 operates on processed data from the sentiment analyzer 120 or the topic classifier 118. In some implementations, the attribute classifier 122 operates directly on bulk data obtained from the data crawler 108, or a combination of bulk data and processed data. In general, attribute classifier 122 identifies and quantifies attributes of the business entity. These can be stored as attributed 138 with the analyzed entities 136 in the entity database 130. Example attributes can include, but are not limited to, product or service provided, number of employees, price (or a price rating), availability, speed (or responsiveness), publicity, customer satisfaction, geographic location, geographic reach, or others. In some implementations, each attribute 138 is also associated with a score or rating (e.g., a 0-10, or 1-5 stars, etc.) and can be made suitable for comparison with other similar entities. Additional example attributes can include, but are not limited to, employee salaries, budgets, funding series or amounts, company maturity (or age of the company), company contact info (e.g., CTO, COO, Head of Product, etc.).

Analyzed entities 136 can be stored in the entity database 130. In some implementations each analyzed entity 136 is categorized, for example, by provided goods or services. Thus the entity database 130 can be queried for specific entities that provide a particular good or service, and their associated attributes 138 can be directly compared. In some implementations, the semantic analysis engine 112 can further provide comparative ratings or an overall score for multiple analyzed entities 136. The entity database 130 can be stored in a memory 128.

Memory 128 of the entity analysis system 102 can represent a single memory or multiple memories. The memory 128 can include any memory or database module and can take the form of volatile or non-volatile memory including, without limitation, magnetic media, optical media, random access memory (RAM), read-only memory (ROM), removable media, or any other suitable local or remote memory component. The memory 128 can store various objects or data, including the entity database 130, user and/or account information, administrative settings, password information, caches, applications, backup data, repositories storing business and/or dynamic information, one or more semantic analysis databases 158 and any other appropriate information associated with the entity analysis system, including any parameters, variables, algorithms, instructions, rules, constraints, or references thereto. Additionally, the memory 128 can store any other appropriate data, such as VPN applications, firmware logs and policies, firewall policies, a security or access log, print or other reporting files, as well as others. While illustrated within the entity analysis system 102, memory 128 or any portion thereof, including some or all of the particular illustrated components, can be located remote from the entity analysis system 102 in some instances, including as a cloud application or repository or as a separate cloud application or repository when the entity analysis 102 itself is a cloud-based system. In some instances, some or all of memory 128 can be located in, associated with, or available through one or more other systems such as the client 170. In those examples, the data stored in memory 128 can be accessible, for example, via one of the described applications or systems.

Semantic analysis database 158 stored in memory 128 can include a database of algorithm weights 160 which includes one or more trained neural networks used by the semantic analysis engine 112. Additionally, the semantic analysis database 158 can include training data 162 for performing additional training or updating the machine learning algorithms 116. Training data 162 can include sample entities 164, which can be labeled data that describes example or sample business entity information that has been processed by a different algorithm or a human. For example, sample entities 164 can include multiple (e.g., tens, hundreds, or more) examples of websites for business entities that have previously been analyzed and categorized. Additionally training data 162 can include sample attributes 166 which describe nominal outputs and can be associated with, or separate from the sample entities 164.

The query engine 124 can interact with one or more client devices 170 using interface 104. It can provide, for example, an API, or other tools for the client 170 to query the entity database 130 in order to assess the analyzed entities 136 therein. The query engine 124 generally permits client(s) 170 to search, filter, sort, and review analyzed entities 136. In some implementations, in response to a query, the query engine 124 provides a ranked list of analyzed entities. Where the entities are ranked based on, for example, the sentiment analyzer's 120 analysis of the attribute classifier's 122 attributes.

A stakeholder notification engine 126 can be provided to provide push notifications to relevant stakeholders. A stakeholder can be a user who has a particular set of responsibilities or interests, or who routinely works in a particular area or field. For example, a user operating a client device 170 may subscribe or otherwise indicate to the entity analysis system 102 that it has a stake in entities that provide “janitorial service” as a service. The stakeholder notification engine 126 can periodically query the entity database 130 and, upon identifying a new analyzed entity with the “janitorial service” attribute, notify the client 170 of the new entity. Additionally, the stakeholder notification engine 126 can provide the new entity's analyzed performance or ranking related to “janitorial service,” and can provide a comparative list of similar entities providing the same service.

External services 182 can be used by the data crawler 108 and the semantic analysis engine 112 to obtain information and attributes of business entities. External services 182 can be, but are not limited to business web pages, third party assessment systems (e.g., crunchbase.com, linkdIn.com, glassdoor.com, etc.), or web based user review systems (e.g., yelp.com, google.com, amazon reviews, etc.). Entity analysis system 102, using data crawler 108, can “scrape” a large number of sources regarding a particular business entity, and as such, can generate large datasets that would not be feasible for a user to collect or analyze.

One or more client devices 170 can interact with system 100. As illustrated, one or more clients 170 can be present in the example system 100. As illustrated, the client 170 can include an interface 172 for communication (similar to or different from interface 104), at least one processor 174 (similar to or different from processor 106), a graphical user interface (GUI) 176, a client application 178, and a memory 180 (similar to or different from memory 128).

The illustrated client 170 is intended to encompass any computing device such as a desktop computer, laptop/notebook computer, mobile device, smartphone, personal data assistant (PDA), tablet computing device, one or more processors within these devices, or any other suitable processing device. In general, the client 170 and its components can be adapted to execute any operating system, including Linux, UNIX, Windows, Mac OS®, Java™, Android™, or iOS. In some instances, the client 170 can comprise a computer that includes an input device, such as a keypad, touch screen, or other device(s) that can interact with one or more client applications, such as one or more dedicated mobile applications, including a mobile wallet or other banking application, and an output device that conveys information associated with the operation of the applications and their application windows to the user of the client 170. Such information can include digital data, visual information, or a GUI 176, as shown with respect to the client 170. Specifically, the client 170 can be any computing device operable to communicate with the entity analysis system 102, other clients 170, and/or other components via network 165, as well as with the network 165 itself, using a wireline or wireless connection. In general, client 170 comprises an electronic computer device operable to receive, transmit, process, and store any appropriate data associated with the system 100 of FIG. 1.

The client application 178 executing on the client 170 can include any suitable application, program, mobile application, or other component. The client application 178 includes communication applications such as SMS, email, or other communications protocols. Client application 178 can interact with the entity system applications (e.g., query engine 124, and the stakeholder notification engine 126) and the entity analysis system 102 via network 165. In some instances, the client application 178 can be a web browser, where the functionality of the client application 178 can be realized using a web application or website the user can interact with via the client application 178. In other instances, the client application 178 can be a remote agent, component, or client-side version of the entity analysis system 102 and/or any of its individual components. In some instances, the client application 178 can interact directly with the entity analysis system 102 or portions thereof. The client application 178 can be used to view, interact with, and subscribe to notifications from the entity database 130. In some instances, the client application 178 may be a mobile application provided by or associated with the entity analysis system 102, such that interactions between the client 170 and the entity analysis system 102 be securely offered using the client application 178.

GUI 176 of the client 170 interfaces with at least a portion of the system 100 for any suitable purpose, including generating a visual representation of any particular client application 178 and/or the content associated with any components of the entity analysis system 102. In particular, the GUI 176 can be used to present results of a business entity query, including providing one or more ranked lists of analyzed entities 136, as well as to otherwise interact and present information associated with one or more applications. GUI 176 can also be used to view and interact with various web pages, applications, and web services located local or external to the client 170. Generally, the GUI 176 provides the user with an efficient and user-friendly presentation of data provided by or communicated within the system. The GUI 176 can comprise a plurality of customizable frames or views having interactive fields, pull-down lists, and buttons operated by the user. In general, the GUI 176 is often configurable, supports a combination of tables and graphs (bar, line, pie, status dials, etc.), and is able to build real time portals, application windows, and presentations. Therefore, the GUI 176 contemplates any suitable graphical user interface, such as a combination of a generic web browser, a web-enable application, intelligent engine, and command line interface (CLI) that processes information in the platform and efficiently presents the results to the user visually.

In some instances, portions of the interactions and entity analysis system 102 data can be stored remotely within memory 180. As illustrated, memory 180 can store information related to instructions for operating various applications (i.e., client application 178) or other information associated with operation of the client 170. In some instances, additional information from the entity database 130 is associated with the client application 178.

While portions of the elements illustrated in FIG. 1 are shown as individual modules that implement the various features and functionality through various objects, methods, or other processes, the software can instead include a number of sub-modules, third-party services, components, libraries, and such, as appropriate. Conversely, the features and functionality of various components can be combined into single components as appropriate.

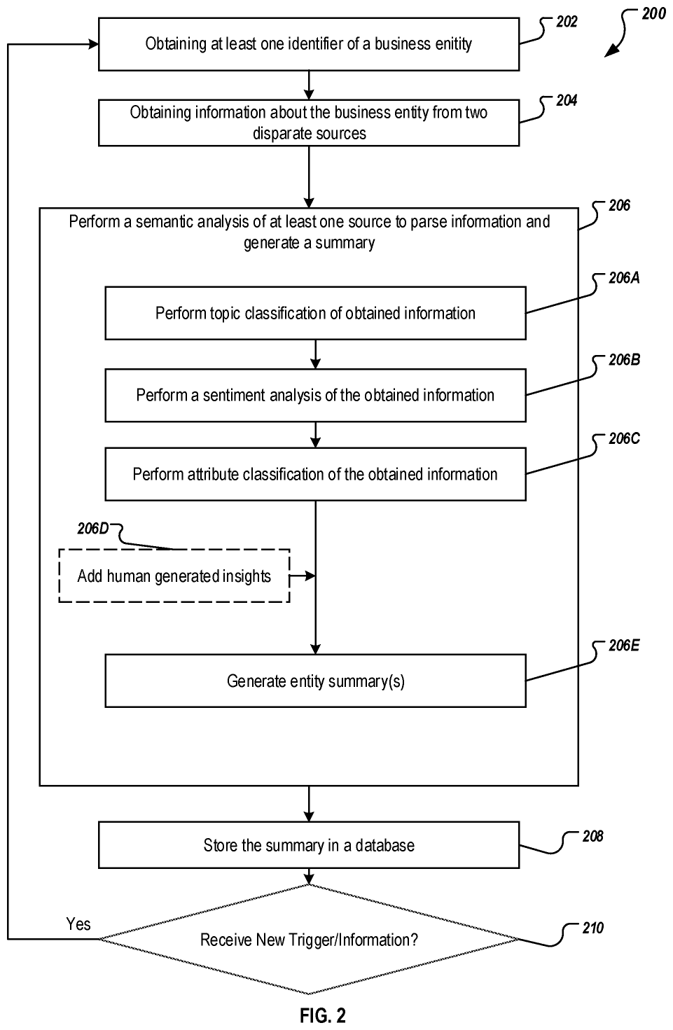

FIG. 2 is a flowchart that describes an example method for automatically analyzing business entities. It will be understood that method 200 may be performed, for example, by any other suitable system, environment, software, and hardware, or a combination of systems, environments, software, and hardware as appropriate. In some instances, method 200 can be performed by the system 100, or portions thereof, described in FIG. 1, as well as other components or functionality described in other portions of this description. In other instances, method 200 may be performed by a plurality of connected components or systems. Any suitable system(s), architecture(s), or application(s) can be used to perform the illustrated operations.

At 202, at least one identifier of a business entity is obtained. The identifier can be, for example, a company or corporation name, a URL, a telephone number, employee ID number, or other means of identifying a particular business entity. The at least one identifier can be obtained via a message received from a user, or from a partner system, which can be provided as a single entity or list of entities. For example, a user can send an email to a dedicated mailbox hosted by a backend system (e.g., entity analysis system 102 as described with respect to FIG. 1). The email can include the identifier in the subject line that the backend system uses to determine a particular business entity or group of business entities on which to perform an analysis. In some implementations, the email's body can include human generated insights or opinions, or additional data, as is discussed in more detail below with respect to 206D. In other instances, additional information may be included in an attachment to the email, including an image or document that includes hand-written or typed notes or commentary.

At 204, information relating to the particular business entity is obtained from two or more disparate sources. These sources can be, but are not limited to, web pages, review compilation pages (e.g., yelp.com, crunchbase.com, etc.), federal and/or state registries (e.g., the Delaware entity search tool), private databases, news articles, or other suitable sources. In some implementations, a data crawler application automatically queries a plurality of databases, performs searches, and extracts information from the results in response to the process being triggered. The information obtained from these sources can be bulk text data, a combination of text and images, metadata, or other suitable data and/or media. In some implementations, the data crawler application may obtain or identify a second data source during an initial scrape of a first data source. For example, the data crawler application may extract some initial data from an external service such as crunchbase.com, which may include a web page that is specific to the particular business entity. The data crawler may then access that web page and extract information from the business entity's page in addition to crunchbase.com. In some implementations, these external sources provide some predefined information such as address, business category, or business age which can be parsed and extracted directly for storage in the summary.

At 206, a semantic analysis of the collected information is performed for at least one data source. In some implementations, a single source is analyzed using semantic analysis. In some implementations, all collected information is analyzed. The semantic analysis can be performed by one or more machine learning algorithms (e.g., machine learning algorithms 116 as described above with respect to FIG. 1) with the overall objective of generating a summary quantifying one or more attributes associated with the business entity in a unified format, where that summary can be stored in a database of other analyzed business entities. The semantic analysis can be performed by an array of neural networks that operate in series as illustrated in example 206A-206C, or can include machine learning algorithms that operate in parallel, or otherwise independently of each other. In some implementations, traditional data analysis can be performed in addition to, or separately from, the machine learning processes.

While illustrated as occurring in series, in some implementations, 204 and 206 occur repeatedly. For example, in some implementations, a semantic analysis of a first source (obtained at 204 and analyzed at 206) can yield additional information sources. Thus a second round of obtaining information from the additional information source, and second round of semantic analysis can be performed. In some implementations, steps 204 and 206 are performed iteratively each time a new information source is discovered.

At 206A, a topic classification algorithm is performed on the obtained information. The topic classification algorithm uses, for example, Latent Semantic Analysis (LSA) and/or Latent Dirichlet Allocation (LDA). Additionally the topic classification algorithm can use one or more bag-of-words libraries, or N-gram libraries to perform an analysis on the obtained information. In general 206A can be used to split the potentially large bulk of obtained information into general topics or categories, which can be filtered and divided, with different machine learning techniques applied to each topic. For example, if one topic is determined to be related to the personal life or hobbies of one or more business directors, information associated with that topic can be deprioritized or ignored entirely, while another topic, for example, customer satisfaction, can be regarded with greater importance and provided to one or more downstream processes for further analyzing (e.g., via sentiment analysis described below).

At 206B, a sentiment analysis is performed for at least a portion of the obtained information. Sentiment analysis can be a separate neural network, or a portion of another process (e.g., topic classification or attribute classification). In some implementations, the sentiment analysis determines a general emotional gist of one or more portions of the obtained information. For example, the sentiment analysis can rate “customer satisfaction” associated with a particular entity on a scale such as: highly dissatisfied, dissatisfied, neutral, satisfied, and highly satisfied. In some implementations, the sentiment analysis provides a binary output (e.g., positive or negative). In some implementations, this sentiment analysis can consider user-inserted insights (as described below with respect to 206D) in order to further assess the entity.

At 206C, attribute classification for the business entity is determined from the obtained information. In general, attribute classification refers to quantifying one or more attributes associated with the entity. Attributes can be, for example, price, responsiveness, employee count, revenue, customer satisfaction, entity age or time in business, type of products/services offered, quality of products/services, or others. These attributes may be determined as a result of processing information from various external services, user reviews, company experiences, or outputs of other machine learning algorithms. In some implementations, the attribute classification receives information from the topic classification at 206A as well as the sentiment analysis at 206B, and the originally obtained information.

At 206D, optionally, if human-generated insights were included in the original prompt or message, those insights can be included in the generated summary here. In some implementations, these human-generated insights are analyzed by the machine learning algorithms prior to being included in the summary. For example, a sentiment analysis and attribute classification can be performed on the human-generated insights. In some implementations, the human-generated insights are direct feedback or experience of the user requesting the analysis. For example these insights could be, “this company was quick to respond to my emails, and very polite!” Such an insight can be afforded more weight when processed during the semantic analysis because it represents recent, and relatively direct feedback regarding the entity being analyzed.

At 206E, a summary of the analysis is generated. In some implementations, the summary is generated in a standard format that describes the business entity, one or more products/services the entity offers, as well as a category for that entity, and other attributes that could be quantified. By providing a standardized summary, direct comparisons of multiple business entities is possible. In some implementations, the semantic analysis performs an immediate ranking of the generated summary with other similar entities. In other implementations, some portions of the

While 206A-206E are illustrated as occurring in a sequential order, it should be noted that these operations can occur in any suitable order, or simultaneously and independent of each other. In some instances, one or more of 206A-206E are not performed, or are only performed for select business entities.

At 208, the generated summary is stored in an entity database. This database can be made available for access by one or more third parties, or can be provided for follow on analysis. The database can be queried for entities of a certain category, or that provide a particular service, and, in response to the query, one or more summaries can be provided, where those summaries quickly display the entity and its associated attributes.

In some implementations, at 210 the database can be automatically maintained. If a new trigger event, or new information is obtained, process 200 can repeat. For example, entity summaries that are stored within the database can be periodically verified by performing a re-analysis for each entity upon all or a portion of the obtained information. In some implementations, each entity is re-queried and new information is gathered periodically in order to perform the re-analysis. In some implementations, these queries can be performed during low demand periods in order to minimize computational load and/or network traffic.

In some implementations, post-generation analysis of the entity summaries can be performed. Specifically, each entity can be ranked for each attribute or category. For example, a general quality ranking can be provided for each entity based on how it compares to other entities within its assigned category. In some implementations, when a query is received that yields two or more results, the results can be automatically compared and ranked by the backend system. The user can then receive an ordered or ranked list with the relative scores displayed for the determined purposes of the user's search. The automatic comparison can determine the sentiment of the user's query, and can weigh or consider the results to that query based on their determined purpose. For example, an entity may be associated with many attributes or search terms. If it is determined that the user is searching for the best custodial service in Dallas, then “Bob's Number 1 Custodial Service” located in downtown Dallas may be a number 1 option relative to a suburb-based “George's Janitorial Service.” If, however, the search relates to offices in one of the nearby suburbs, the ranking order may change based on the context of the search.

In some implementations, if a given user is interested in a particular product, service, or other attribute, the user can subscribe to receive push notification when new entities are analyzed that include the attribute or product/service of interest. Additionally, when entities are updated or re-analyzed, and their attribute or product/service of interest changes, the subscribed user can be notified of those changes. This can include changes provided by third party users. For example, if a user is subscribed to “janitorial services” and a particular entity was previously ranked poorly, but new information in the form of a positive human generated insight is incorporated into the summary, the subscribed user can be notified of the change in that entity's rank. This can allow users to quickly adapt their entity relationships as information changes, without the labor of manually maintaining comparisons between many competing business entities.

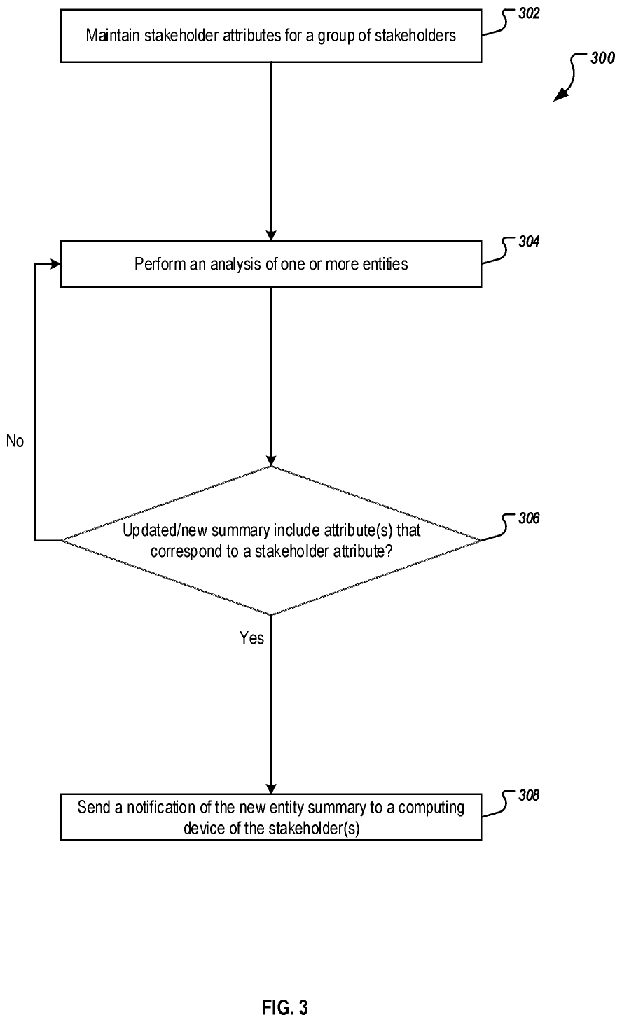

FIG. 3 is a flowchart that describes an example method for sending push notifications to stakeholders. It will be understood that method 300 may be performed, for example, by any other suitable system, environment, software, and hardware, or a combination of systems, environments, software, and hardware as appropriate. In some instances, method 300 can be performed by the system 100, or portions thereof, described in FIG. 1, as well as other components or functionality described in other portions of this description. In other instances, method 300 may be performed by a plurality of connected components or systems. Any suitable system(s), architecture(s), or application(s) can be used to perform the illustrated operations.

At 302, stakeholder attributes are maintained for a group of stakeholders. A stakeholder can be a user who has a particular set of responsibilities or interests, or who routinely works in a particular area or field. For example, a user operating a client device may subscribe or otherwise indicate that it has a stake in entities that provide “janitorial service” as a service. This can be registered in a database for future notifications to be sent to the stakeholder.

At 304, an analysis is performed on one or more entities. This analysis can be, for example process 200 as described above with respect to FIG. 2. In some implementations, the analysis ends in a summary that is stored in an entity database.

At 306, When that analysis of 304 results in a new or updated summary that includes an attribute to which the stakeholder has subscribe, or that is otherwise identified as corresponding to a stakeholder attribute, process 300 proceeds to 308. If no new or updated summary was generated, then process 300 returns to 304 and awaits further analysis.

At 308, when a stakeholder attribute has been updated, or a new attribute has been identified, a notification (e.g., push notification, email, SMS, or other message) is sent to a computing device associated with the stakeholder. In some implementations, the notification includes the summary, or a link to the summary that was generated and includes the updated or new attribute.

The preceding figures and accompanying description illustrate example processes and computer-implementable techniques. However, system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, the described systems and flows may use processes and/or components with or performing additional operations, fewer operations, and/or different operations, so long as the methods and systems remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

1. A system comprising:
at least one memory storing instructions;
at least one hardware processor interoperably coupled with the at least one memory, wherein the instructions instruct the at least one hardware processor to perform operations including:
obtaining at least one identifier of an entity;
obtaining, automatically based on the at least one identifier, information about the entity from at least two disparate sources;
parsing, based on a semantic analysis of at least one source, the obtained information to generate a summary of the entity comprising one or more attributes associated with the entity; and
storing the summary of the entity in a database.

2. The system of claim 1, wherein parsing the obtained information comprises:
determining, by executing a machine learning model, the one or more attributes associated with the entity, wherein the machine learning model is trained using sample information of a plurality of sample entities and a plurality of sample attributes associated with the plurality of sample entities.

3. The system of claim 2, wherein the one or more attributes associated with the entity comprise a category of the entity indicating a product or a service provided by the entity.

4. The system of claim 2, wherein executing the machine learning model and determining the one or more attributes comprises:
performing a topic classification of the obtained information;
performing a sentiment analysis of the obtained information; and
performing attribute classification of the obtained information.

5. The system of claim 1, comprising:
maintaining stakeholder attributes of a plurality of stakeholders, each stakeholder corresponding to one or more stakeholder attributes;
determining that at least one of the one or more attributes associated with the entity corresponds to a stakeholder attribute of a stakeholder; and
sending the summary of the entity to a computing device of the stakeholder.

6. The system of claim 1, comprising:
receiving a query request to query entities, wherein the query request comprises one or more keywords;
determining that an attribute of a particular entity corresponds to the one or more keywords; and
sending a summary of the particular entity in response to the query request.

7. The system of claim 6, wherein determining that an attribute of a particular entity corresponds to the one or more keywords comprises determining that an attribute of two or more particular entities correspond to the one or more keywords, the operations further comprising:
generating a comparison between the two or more particular entities based on a generated relevance score between the one or more keywords and the determined attribute;
sending the generated comparison of the two or more particular entities in response to the query request.

8. The system of claim 1, wherein obtaining the at least one identifier of an entity comprises receiving an email, wherein a subject of the email contains the identifier.

9. The system of claim 8, wherein a body of the email comprises human-generated insights associated with the entity, and wherein the human generated insights are stored with the summary in the database.

10. The system of claim 9, wherein the human generated insights comprise a score of the entity that is associated with a category of the entity.

11. The system of claim 1, wherein parsing the obtained information to generate a summary of the entity comprises:
identifying an additional source and extracting additional information about the entity from the additional source; and
performing an additional semantic analysis of the additional source.

12. A computer-implemented method comprising:
obtaining at least one identifier of an entity;
obtaining, automatically based on the at least one identifier, information about the entity from at least two disparate sources;
parsing, based on a semantic analysis of at least one source, the obtained information to generate a summary of the entity comprising one or more attributes associated with the entity; and
storing the summary of the entity in a database.

13. The method of claim 12, wherein parsing the obtained information comprises:
determining, by executing a machine learning model, the one or more attributes associated with the entity, wherein the machine learning model is trained using sample information of a plurality of sample entities and a plurality of sample attributes associated with the plurality of sample entities.

14. The method of claim 13, wherein the one or more attributes associated with the entity comprise a category of the entity indicating a product or a service provided by the entity.

15. The method of claim 13, wherein executing the machine learning model and determining the one or more attributes comprises:
performing a topic classification of the obtained information;
performing a sentiment analysis of the obtained information; and
performing attribute classification of the obtained information.

16. The method of claim 12, comprising:
maintaining stakeholder attributes of a plurality of stakeholders, each stakeholder corresponding to one or more stakeholder attributes;
determining that at least one of the one or more attributes associated with the entity corresponds to a stakeholder attribute of a stakeholder; and
sending the summary of the entity to a computing device of the stakeholder.

17. The method of claim 12, comprising:
receiving a query request to query entities, wherein the query request comprises one or more keywords;
determining that an attribute of a particular entity corresponds to the one or more keywords; and
sending a summary of the particular entity in response to the query request.

18. A non-transitory, computer-readable medium storing computer-readable instructions executable by a computer and configured to perform operations comprising:
obtaining at least one identifier of an entity;
obtaining, automatically based on the at least one identifier, information about the entity from at least two disparate sources;
parsing, based on a semantic analysis of at least one source, the obtained information to generate a summary of the entity comprising one or more attributes associated with the entity; and
storing the summary of the entity in a database.

19. The computer-readable medium of claim 18, wherein parsing the obtained information comprises:
determining, by executing a machine learning model, the one or more attributes associated with the entity, wherein the machine learning model is trained using sample information of a plurality of sample entities and a plurality of sample attributes associated with the plurality of sample entities.

20. The computer-readable medium of claim 19, wherein the one or more attributes associated with the entity comprise a category of the entity indicating a product or a service provided by the entity.
